(19) United States
(12) Patent Application Publication
(10) Pub. No.: US 2022/0381224 A1
(43) Pub. Date: Dec. 1, 2022

(54) Vertical Tilting Blade Turbine Wind Mill

(71) Applicant: Damodaran Ethiraj, T Nagar (IN)

(72) Inventor: Damodaran Ethiraj, T Nagar (IN)

(21) Appl. No.: 17/664,247

(22) Filed: May 20, 2022

Related U.S. Application Data
(63) Continuation-in-part of application No. 17/303,323, filed on May 26, 2021.

(51) Int. Cl. F03D 7/06; F03D 3/00; F03D 9/25; F03D 15/00; F03D 80/70; H02K 7/116; H02K 7/18

(52) U.S. Cl. CPC F03D 7/06; F03D 3/005; F03D 9/25; F03D 15/00; F03D 80/70; H02K 7/116; H02K 7/183; F05B 2220/706; F05B 2240/50; F05B 2260/74

(57) ABSTRACT

The Vertical Tilting Blade Turbine Windmill device is for capturing kinetic energy from the wind and is comprised of a vertical shaft having a central hub connectively attached, the central hub having a plurality of wind capture arms comprising a rotating wind capture blade having a capture surface and a slicing edge that are rotated wherein the wind capture blades are rotated between a blade mode to capture the wind and a knife mode to pass with less drag resistance through the air/wind thereby enabling an increase in the ability to capture more of the energy available in an on-coming wind stream.

### TECHNICAL FIELD OF THE INVENTION

This invention relates generally to a vertically oriented windmill having a wind turbine with a plurality of wind capture blades/arms to capture the wind for conversion into electrical energy by rotating a shaft in an electrical generator. This invention relates generally to fixed blade wind turbines, and more specifically to variable rotating blade wind turbines.

This invention relates specifically to a variable tilting blade turbine windmill in the form of a drive shaft driven by a plurality of wind capture blade sets (turbines) connectively attached to a shaft wherein said wind capture blades are rotated about their attached rods between presenting a flat surface to capture the wind and an edge to slice through the wind for the purpose of increasing the effectiveness of wind capture by enabling the wind capture blades to be mechanically rotated to present a flat (cupping) capture surface when facing a wind and mechanically rotated to slice through the wind presenting only an edge of the wind capture blade when not in an ideal location to capture wind.

### BACKGROUND

Today there are windmills operating all over the world having fixed wind capture blade turbines. In order to increase the torque (force) of blade movement about the connected shaft long narrow blades with a bulge or widening at the bottom (free end) are used.

The nature of the fixed blade design results in wind drag at various points during the wind capture blades movement around an attached shaft which results in windmills being able to harvest and convert to electrical energy only capturing about thirty to thirty-five percent of the available energy present in the wind.

In light of the foregoing prior art, there is a need for a rotating blade wind capture turbine to better collect/harvest the available energy present in the wind for conversion into electrical energy.

In light of the foregoing prior art, there is a need for a device with two or more rotating blade wind capture turbines to better collect/harvest/capture the available energy present in the wind enabling an increased conversion of wind energy into electrical energy.

### BRIEF SUMMARY OF THE INVENTION

According to a first aspect of the invention, there is a vertically oriented variable tilting blade windmill device for capturing kinetic energy from a wind comprising a vertical rotating drive shaft having a top end opposing a bottom end, a central hub connectively attached to said top end having at least one wind capture arm comprising a wind capture blade having a capture surface, a slicing edge, and a rubber lining proximal to said slicing edge comprising an inner blade rod having a length and a first base end attached to said drive shaft through said central hub, and an outer blade sleeve having a second base end with an upper blade guide post opposite a lower blade guide post to limit rotation of said wind capture blade wherein said outer blade sleeve is positioned to contain a majority of said inner blade rod and wherein said wind capture blade is attached lengthwise to said outer blade sleeve, and a blade guide ring continuous for up to two hundred forty degrees arc surrounding said vertical rotating drive shaft positioned to rotate said wind capture blade ninety degrees arc around said inner blade rod as said wind pushes against said wind capture blade causing said central hub to rotate causing said wind capture blade to pass over said blade guide ring.

According to a second aspect of the invention, there is a vertically oriented variable tilting blade windmill wherein said wind capture blade further comprising a roller wheel operationally attached to said second base opposite said rubber lining, and said blade guide ring comprises a roller wheel on-ramp end opposite a roller wheel off-ramp end positioned to rotate said wind capture blade by causing said roller wheel to rotate said outer blade sleeve around said inner blade rod by up to ninety degrees as said wind pushes against said wind capture blade causing said central hub to rotate causing said wind capture blade to pass over said blade guide ring.

According to a third aspect of the invention, there is a vertically oriented variable tilting blade windmill wherein said wind capture blade further comprising at least one rolling bearing operationally attached around said bottom end to enable rotation of said vertical rotating drive shaft about an attachment point which said rolling bearing is externally attached to.

According to a fourth aspect of the invention, there is a vertically oriented variable tilting blade windmill further comprising an electrical generator connectively attached to said bottom end of said vertical rotating drive shaft enabling a generation of electricity.

According to a fifth aspect of the invention, there is a vertically oriented variable tilting blade windmill further comprising an electrical generator connectively attached to said bottom end of said rotating drive shaft enabling a generation of electricity.

According to a sixth aspect of the invention, there is a vertically oriented variable tilting blade windmill wherein when said wind capture blade is rotated into a knife mode when positioned over said blade guide ring presenting said slicing edge to said wind and wherein said wind capture blade is rotated into a knife mode when not positioned over said blade guide ring presenting said capture surface to said wind.

According to a seventh aspect of the invention, there is a vertically oriented variable tilting blade windmill wherein when said wind capture blade is rotated into a knife mode when positioned over said blade guide ring presenting said slicing edge to said wind and wherein said wind capture blade is rotated into a knife mode when not positioned over said blade guide ring presenting said capture surface to said wind.

According to an eighth aspect of the invention, there is a vertically oriented variable tilting blade windmill device for capturing kinetic energy from a wind comprising a vertical rotating drive shaft having a top end opposing a bottom end, a central hub connectively attached to said top end having at least one wind capture arm comprising a wind capture blade having a capture surface and a slicing edge comprising an inner blade rod having a length and a first base end attached to said drive shaft through said central hub, an outer blade sleeve having a second base end, and a roller wheel operationally attached to said second base wherein said wind capture blade is attached lengthwise to said outer blade sleeve, and a blade guide ring having a roller wheel on-ramp end opposite a roller wheel off-ramp end continuous for up to two hundred forty degrees arc surrounding said vertical rotating drive shaft positioned to rotate said wind capture blade by causing said roller wheel to rotate said outer blade sleeve around said inner blade rod by up to ninety degrees as said wind pushes against said wind capture blade causing said central hub to rotate causing said wind capture blade to pass over said blade guide ring.

According to a ninth aspect of the invention, there is a vertically oriented variable tilting blade windmill wherein said second base end further comprises connectively attached an upper blade guide post positioned ninety degrees arc away from a lower blade guide post to limit rotation of said wind capture blade.

According to a tenth aspect of the invention, there is a vertically oriented variable tilting blade windmill wherein said wind capture blade further comprises a rubber lining opposite said roller wheel.

According to an eleventh aspect of the invention, there is a vertically oriented variable tilting blade windmill further comprising at least one rolling bearing operationally attached around said bottom end to enable rotation of said vertical rotating drive shaft about an attachment point which said rolling bearing is externally attached to.

According to a twelfth aspect of the invention, there is a vertically oriented variable tilting blade windmill further comprising an electrical generator connectively attached to said bottom end of said rotating drive shaft enabling a generation of electricity.

According to a thirteenth aspect of the invention, there is a vertically oriented variable tilting blade windmill further comprising an electrical generator connectively attached to said bottom end of said rotating drive shaft enabling a generation of electricity.

According to a fourteenth aspect of the invention, there is a vertically oriented variable tilting blade windmill wherein when said wind capture blade is rotated into a knife mode when positioned over said blade guide ring presenting said slicing edge to said wind and wherein said wind capture blade is rotated into a knife mode when not positioned over said blade guide ring presenting said capture surface to said wind.

According to a fifteenth aspect of the invention, there is a vertically oriented variable tilting blade windmill wherein when said wind capture blade is rotated into a knife mode when positioned over said blade guide ring presenting said slicing edge to said wind and wherein said wind capture blade is rotated into a knife mode when not positioned over said blade guide ring presenting said capture surface to said wind.

An advantage of the variable tilting blade turbine windmill device is the capacity/capability to collect/harvest more of the available energy present in the wind for conversion into electrical energy than currently available windmills.

An advantage of the present invention is the increased conversion of wind energy into electrical energy.

The invention will now be described, by way of example only, with reference to the accompanying drawings in which:

### BRIEF DESCRIPTION OF THE DRAWINGS

FIG. 1 is a perspective view of a variable tilting blade turbine windmill having one central hub having four wind capture blades connectively attached according to the invention; and

FIG. 2 is a cutaway view of a variable tilting blade turbine windmill having one central hub having four wind capture blades connectively attached according to the invention.

### DETAILED DESCRIPTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” etcetera, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Index of Labelled Features in Figures. Features are listed in numeric order by Figure in numeric order.

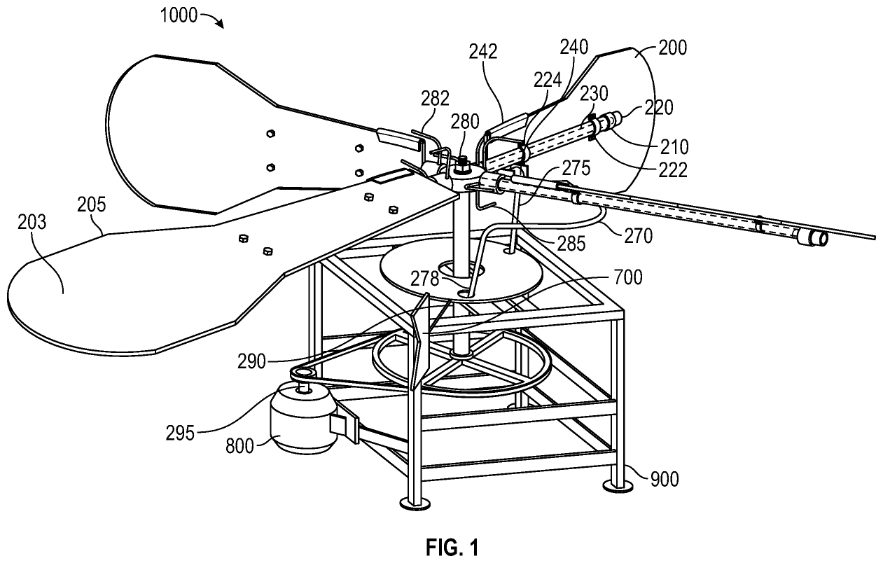

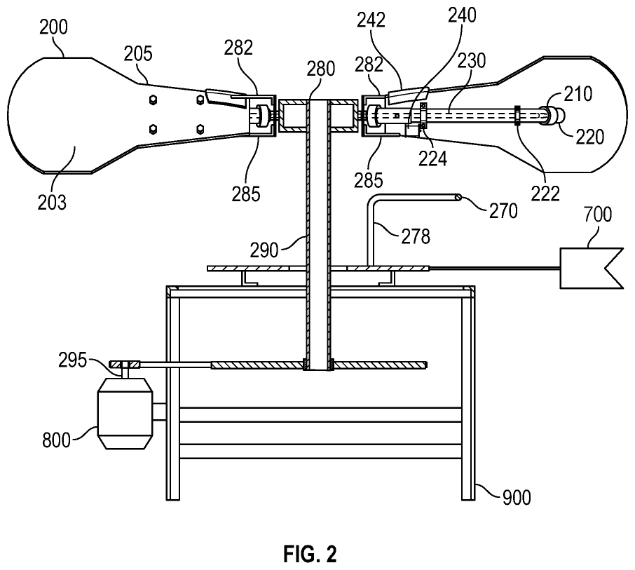

Referring to the Figures, there is shown in FIGS. 1 and 2 the following features:

Element 1000 which is a variable tilting blade turbine windmill device/apparatus.

Element 200 which is a wind capture blade.

Element 203 which is a wind capture surface of a wind capture blade.

Element 205 which is a wind slicing edge of a wind capture blade.

Element 210 which is an outer blade sleeve.

Element 212 which is a blade sleeve cup.

Element 220 which is a rolling bearing cap.

Element 222 which is a lower strap.

Element 224 which is an upper strap.

Element 230 which is an inner blade rod.

Element 240 which is a roller wheel.

Element 242 which is a rubber lining.

Element 270 which is a blade guide ring.

Element 275 which is a roller wheel blade guide ring ramp.

Element 278 which is a roller wheel blade guide ring ramp.

Element 280 which is a central hub.

Element 282 which is an upper blade guide post.

Element 285 which is a lower blade guide post.

Element 290 which is a vertical axis shaft.

Element 295 which is a rolling bearing.

Element 700 which is a wind vane.

Element 800 which is an electrical generator.

Element 900 which is a windmill stand.

Special definitions of terms used. Where the term “blade-mode” is used it is intended to imply a maximized surface area presentation of a wind capture blade. For example when a wind capture blade is a facing a wind to in order to capture wind energy. Where the term “knife-mode” is used it is intended to imply a minimized surface area presentation of a wind capture blade to present less surface area and therefore cause less drag against the rotation of a shaft. For example when a wind capture blade is opposing a facing wind.

Generally the apparatus/device of the present invention is a vertically oriented tilting blade turbine windmill that is connectively and operationally attached to a shaft so as to rotate the shaft in an electrical generator and thereby generate electricity.

The manually operating embodiment of the device/apparatus of the present invention is made by assembling a plurality of wind capture blades about a central hub to rotate a shaft. The wind capture blades comprise an assembly of an inner blade rod connectively attached to a shaft wherein said inner blade rod is enclosed with an outer blade sleeve attached to the end of the inner blade rod with a roller wheel for rotating said outer blade sleeve about the longitudinal axis of said inner blade rod. Said outer blade sleeve is connectively attached to said wind capture blade with a lower strap and an upper strap. This enables the wind capture blade to be rotated about the longitudinal axis of said inner blade rod.

Controlling the rotation of the wind capture blades enables the device of the present invention to rotate between presenting a flat surface to capture the wind and an edge to slice through the wind for the purpose of increasing the effectiveness of wind capture by enabling the wind capture blades to be mechanically rotated to present a flat capture surface when facing a wind and mechanically rotated to slice through the wind when not in an ideal location to capture wind. The rotation of the wind capture blades by ninety degrees of arc/rotation from a full flat surface presentation to capture the wind in a blade-mode to a knife-mode wherein the wind capture blade is in an edge presentation to slice through, or pass through, the air/wind with less resistance results in less drag being imposed on a windmill by the fixed positioning of the blades consequently reducing the energy loss of the windmill system and thereby increasing the energy harvesting capacity of a windmill enabled with the device/apparatus of the present invention.

Switching the wind capture blades of a windmill enabled with the device of the present invention between blade-mode and knife-mode can be enabled as in mechanically to rotate said wind capture blade in blade-mode presentation over a blade guide ring into knife-mode presentation and then rotate said wind capture blade back to blade-mode when said wind capture blade pass over the end of the blade guide ring. Rotation is the wind capture blade is maintained in the correct position by the installation (connective attachment) of a plurality of blade guide posts positioned around the base end of the wind capture blade proximal to the shaft or attachment end of the inner blade rod to maximize the capture of a wind for conversion to electrical energy by rotating the shaft/drive shaft through an electrical generator.

Switching the wind capture blades of a windmill enabled with the device of the present invention between blade-mode and knife-mode can be enabled automatically with the installation of wind direction device to determine the wind direction enabling the movement of said wind capture blades between blade-mode and knife-mode at any rotational position required to maximize the capture of a wind for conversion to electrical energy by rotating the shaft/drive shaft through an electrical generator.

The wind capture blades of the present invention are best embodied wherein the shape of the blade is designed/constructed in a rectangular, flat and broad (wide) configuration/size/shape to maximize surface area presentation in blade-mode, and minimize the surface area in knife-mode. Manual or automated gears and/or the combination of physical limiting controls presented by a tilting lever, blade guide ring, and blade guide posts can be used to control whether and when/where in/during the rotation of the wind capture blades about the shaft occurs to place the wind capture blades into blade-mode or knife-mode.

Configuring the device of the present invention to present blade-mode during the primary wind front half of the wind capture blades rotation around the shaft and to present knife-mode during the other half of the rotation has the impact of offer a windmill turbine that has decreased drag during the knife-mode blade presentation thereby resulting in a corresponding increase of capacity of said windmill to capture or harvest energy from the wind. With the wind capture blades in blade-mode they are forced by the wind with less resistance presented by the blades in knife-mode resulting in less energy loss into the windmill as a system from wind capture blades not present in the wind stream when not in a location of rotation to be useful for capturing wind and thereby resulting in more energy transfer (harvesting) of energy available in the wind.

Using the device of the present invention is best made by determining the wind direction and resulting primary wind force profile presented to a windmill by the wind, and then configuring the blades to be in blade-mode for the primary wind force profile half of the turbines rotation and in knife-mode for the part(s) not as useful for collecting wind energy. The transition between blade-mode and knife-mode can occur at any or multiple locations during a full rotation of the turbine. The present preferred embodiment uses up to 240° arc for blade-mode including the transition distance covered switching between modes and 120° arc for knife-mode.

The improved energy transfer from windmill to generator resulting from the decrease in drag resulting from the blades in knife-mode presenting minimum wind resistance and therefore less energy consumption to rotate a turbine is apparent. However, the present invention offers the capacity to enable the wind capture blades to scoop or cup the wind during transition from blade-mode to knife-mode and during transition from knife-mode to blade-mode creating a rotating scoop with the wind capture blade resulting in an increase in the energy capture from wind and resulting energy conversion into electricity.

In an embodiment, there is a vertical axis turbine. The vertical axis turbine embodiment is distinctive having a single hub attached to a vertical axis shaft 290 wherein the blades are reoriented mechanically as the blade arms pass over the gliding ring with tilting leavers 282, 285 as shown in the drawings.

In an embodiment, there is a vertically oriented variable tilting blade turbine windmill device for capturing kinetic energy from a wind comprising a shaft having a first end and a second end wherein said second end is attached to rotate a drive shaft, a central hub connectively attached to said first end having a plurality of wind capture arms comprising a wind capture blade having a capture surface and a slicing edge comprising an inner blade rod having a base end connectively attached to said shaft proximal to said central hub, an outer blade sleeve enclosing a majority of the length of said inner blade rod.

In an embodiment, there is a vertically oriented variable tilting blade turbine windmill device wherein said drive gear is connectively attached to said central hub at a right angle enabling a rotation of said outer blade sleeve.

In an embodiment, there is a vertically oriented variable tilting blade turbine windmill device wherein said wind capture blades have a push orientation positioned wherein said capture surface is positioned facing an on-coming wind and are rotated by said wind through a rotation about said shaft of between 120° and 240° and are then rotated 90° to present said slicing edge in the direction of said wind enabling said wind capture blade to present a minimized aerodynamic profile in the direction of said wind.

In an embodiment, there is a vertically oriented variable tilting blade turbine windmill device further comprising a tilting lever for mechanically rotating connectively attached to said central hub configured to enable a rotation up to 90° of said wind capture blades about said inner blade shaft upon rotation of said central hub, a blade guide ring positioned to surround up to 120° of arc proximal to said shaft enabling a rotation of 90° of said wind capture blades about said inner blade shaft upon said wind capture blades passing over said blade guide ring, and a plurality of blade guide posts positioned to stop a rotation of each wind capture blade about said inner blade shaft upon rotation of said wind capture blades.

In an embodiment, there is a vertically oriented variable tilting blade turbine windmill device further comprising a wind vane device having a wind direction vector, a drive controller having a rotation control based on said wind direction vector, and a plurality of drive motors operationally attached to said drive controller to operate said drive gears enabling an programmable automated clockwise rotation up to 90° of said wind capture blades about said inner blade shaft and a counterclockwise rotation up to 90° of said wind capture blades about said inner blade shaft depending upon said wind direction vector.

In an embodiment, there is a vertically oriented variable tilting blade turbine windmill device further comprising an electrical generator connectively attached to said drive shaft enabling a generation of electricity.

The device of the present invention has several advantages. It offers decreased wind capture blade resistance resulting in greater energy transfer conversion into electrical energy by enabling several new ways to use the rotating wind capture blades.

The rotating blade wind turbines created to embody the present invention offer the advantage of less drag from the blades in knife-mode resulting in less consumption of energy by the turbine resulting in more energy transfer into the shaft and the resulting increase in energy harvest from the wind. Another advantage of the present invention is the ability to configure the presentation (blade-mode, or knife-mode), timing, and location of change in wind capture blade orientation (blade-mode, or knife-mode) for each wind capture blade.

When embodied for automatic rotation, there is the further advantage of the present invention to scoop, cup, or grab more air resulting in more energy transfer from wind to wind capture blade and its corresponding increase in energy transfer from the wind into electrical energy with a windmill enabled with the device of the present invention. The capacity to configure the arc length, timing, and duration for the wind capture blade to stay in blade-mode permits an operator to adjust the windmill to maximize blade-mode presentation to keep the wind capture blades in blade-mode for at least that half of the turbine rotation where the wind is its strongest within the wind profile offer to the windmill.

Increased conversion of wind energy into electrical energy is accomplished with the present invention by presenting less surface area of the wind capture blade during the time when the wind capture blade in a location that it would present movement resistance, and maximum surface area when the wind capture blade in a location that it would capture wind movement.

An advantage of the present invention is the increased conversion of wind energy into electrical energy. Because of the variable surface presentation available for the wind capture blades of the tilting blade turbine windmill device, the wind capture blades of the present invention are able to functionally present its largest available surface area to be pushed by the wind when the wind is moving at, or about, a right angle to the wind capture blade surface, and its smallest available surface area to slice/cut through the wind with less drag or resistance when the direction of the wind capture blade is moving against the wind. The wind capture blades effectively cup the wind when presented with a wind direction facing the wind capture blades, and slice through the wind presenting less resistance when moving contrary to a direction to capture the wind.

The half to three-quarters of the rotation of the turbine that has the wind capture blades in blade-mode can even be adjusted to feather (delicately transition into) blade-mode into knife-mode and to feather knife-mode into blade mode. Feathering or easing (longer time to rotate) between blade modes allows a windmill turbine to be configured to scoop, cup, or grab the wind at the points where the wind capture blades transition between modes similar to a passenger in a automobile flying their cupped hand out an open car window.

In a preferred embodiment of the invention, there is a vertically oriented variable tilting blade windmill device for capturing kinetic energy from a wind comprising a vertical rotating drive shaft having a top end opposing a bottom end, a central hub connectively attached to said top end having at least one wind capture arm comprising a wind capture blade having a capture surface, a slicing edge, and a rubber lining proximal to said slicing edge comprising an inner blade rod having a length and a first base end attached to said drive shaft through said central hub, and an outer blade sleeve having a second base end with an upper blade guide post opposite a lower blade guide post to limit rotation of said wind capture blade wherein said outer blade sleeve is positioned to contain a majority of said inner blade rod and wherein said wind capture blade is attached lengthwise to said outer blade sleeve, and a blade guide ring continuous for up to two hundred forty degrees arc surrounding said vertical rotating drive shaft positioned to rotate said wind capture blade ninety degrees arc around said inner blade rod as said wind pushes against said wind capture blade causing said central hub to rotate causing said wind capture blade to pass over said blade guide ring.

In an alternate embodiment of the invention, there is a vertically oriented variable tilting blade windmill device further comprising a roller wheel operationally attached to said second base opposite said rubber lining, and said blade guide ring comprises a roller wheel on-ramp end opposite a roller wheel off-ramp end positioned to rotate said wind capture blade by causing said roller wheel to rotate said outer blade sleeve around said inner blade rod by up to ninety degrees as said wind pushes against said wind capture blade causing said central hub to rotate causing said wind capture blade to pass over said blade guide ring.

In an alternate embodiment of the invention, there is a vertically oriented variable tilting blade windmill device further comprising at least one rolling bearing operationally attached around said bottom end to enable rotation of said vertical rotating drive shaft about an attachment point which said rolling bearing is externally attached to.

In an alternate embodiment of the invention, there is a vertically oriented variable tilting blade windmill device further comprising g an electrical generator connectively attached to said bottom end of said vertical rotating drive shaft enabling a generation of electricity.

In an alternate embodiment of the invention, there is a vertically oriented variable tilting blade windmill device further comprising an electrical generator connectively attached to said bottom end of said rotating drive shaft enabling a generation of electricity.

In an alternate embodiment of the invention, there is a vertically oriented variable tilting blade windmill device wherein when said wind capture blade is rotated into a knife mode when positioned over said blade guide ring presenting said slicing edge to said wind and wherein said wind capture blade is rotated into a knife mode when not positioned over said blade guide ring presenting said capture surface to said wind.

In an alternate embodiment of the invention, there is a vertically oriented variable tilting blade windmill device wherein when said wind capture blade is rotated into a knife mode when positioned over said blade guide ring presenting said slicing edge to said wind and wherein said wind capture blade is rotated into a knife mode when not positioned over said blade guide ring presenting said capture surface to said wind.

In a preferred embodiment of the invention, there is a vertically oriented variable tilting blade windmill device for capturing kinetic energy from a wind comprising a vertical rotating drive shaft having a top end opposing a bottom end, a central hub connectively attached to said top end having at least one wind capture arm comprising a wind capture blade having a capture surface and a slicing edge comprising an inner blade rod having a length and a first base end attached to said drive shaft through said central hub, an outer blade sleeve having a second base end, and a roller wheel operationally attached to said second base wherein said wind capture blade is attached lengthwise to said outer blade sleeve, and a blade guide ring having a roller wheel on-ramp end opposite a roller wheel off-ramp end continuous for up to two hundred forty degrees arc surrounding said vertical rotating drive shaft positioned to rotate said wind capture blade by causing said roller wheel to rotate said outer blade sleeve around said inner blade rod by up to ninety degrees as said wind pushes against said wind capture blade causing said central hub to rotate causing said wind capture blade to pass over said blade guide ring.

In an alternate embodiment of the invention, there is a vertically oriented variable tilting blade windmill device wherein said second base end further comprises connectively attached an upper blade guide post positioned ninety degrees arc away from a lower blade guide post to limit rotation of said wind capture blade.

In an alternate embodiment of the invention, there is a vertically oriented variable tilting blade windmill device wherein said wind capture blade further comprises a rubber lining opposite said roller wheel.

In an alternate embodiment of the invention, there is a vertically oriented variable tilting blade windmill device further comprising at least one rolling bearing operationally attached around said bottom end to enable rotation of said vertical rotating drive shaft about an attachment point which said rolling bearing is externally attached to.

In an alternate embodiment of the invention, there is a vertically oriented variable tilting blade windmill device further comprising an electrical generator connectively attached to said bottom end of said rotating drive shaft enabling a generation of electricity.

In an alternate embodiment of the invention, there is a vertically oriented variable tilting blade windmill device further comprising an electrical generator connectively attached to said bottom end of said rotating drive shaft enabling a generation of electricity.

In an alternate embodiment of the invention, there is a vertically oriented variable tilting blade windmill device wherein when said wind capture blade is rotated into a knife mode when positioned over said blade guide ring presenting said slicing edge to said wind and wherein said wind capture blade is rotated into a knife mode when not positioned over said blade guide ring presenting said capture surface to said wind.

In an alternate embodiment of the invention, there is a vertically oriented variable tilting blade windmill device wherein when said wind capture blade is rotated into a knife mode when positioned over said blade guide ring presenting said slicing edge to said wind and wherein said wind capture blade is rotated into a knife mode when not positioned over said blade guide ring presenting said capture surface to said wind.

To rotate the wind capture blade a blade guide ring ramp with gradual climb at one end continues up to 240 degrees arc surrounding the said vertical shaft ending abruptly at the other end the flowing wind forces blade to hit the ramp wherein the rear bottom roller wheel starts to climb the ramp leading to 90 degree anti clockwise rotation resulting in knife mode travel till the ramp abrupt end making it to fall instantly due to withdrawal of ramp support to roller wheel causing 90 degree clockwise rotation forcing it to resume blade orientation, and a blade upper guide post lever keep the said blade to continue in blade mode by pressing its upper end from tilting over due to wind pressure another lower guide post lever keep the blade forward end in level with guide ring ramp in knife mode while travel against the wind.

For harvesting maximum torque and energy from wind it should be blocked with wide blades but at the same time the turbine should rotate for generating electrical energy.

To achieve this, tilting blade concept was conceived, through which the blade with its dual mode harvest energy present in the wind and as well travel against it in knife mode. Wind vane attached with the plate on which the guide ring rest should be held firmly so that the blade roller wheel climbs it with out causing disturbance to the turbine rotation.

To rotate the wind capture blade a blade guide ring ramp with gradual climb at one end continues up to 240 degrees arc surrounding the said vertical shaft ending abruptly at the other end the flowing wind forces blade to hit the ramp wherein the rear bottom roller wheel starts to climb the ramp leading to 90 degree anti clockwise rotation resulting in knife mode travel till the ramp abrupt end making it to fall instantly due to withdrawal of ramp support to roller wheel causing 90 degree clockwise rotation forcing it to resume blade orientation, and a blade upper guide post lever keep the said blade to continue in blade mode by pressing its upper end from tilting over due to wind pressure another lower guide post lever keep the blade forward end in level with guide ring ramp in knife mode while travel against the wind.

For harvesting maximum torque and energy from wind it should be blocked with wide blades but at the same time the turbine should rotate for generating electrical energy.

To achieve this, tilting blade concept was conceived, through which the blade with its dual mode harvest energy present in the wind and as well travel against it in knife mode. Wind vane attached with the plate on which the guide ring rest should be held firmly so that the blade roller wheel climbs it with out causing disturbance to the turbine rotation.

Construction and functioning details. The vertical shaft of the mill is housed in a tubular structure with bearings at its ends, to enable free rotation of the vertical shaft. The tubular housing is fixed on a square plate with a hole in the middle, which in turn is mounted on the mill tower. The vertical shift's one end would be facing the sky and the other at the earth. A circular hub is mounted at the skyward end of the shaft with locking mechanism secured with fastener. The longitudinal blade rod's bottom end is screwed in to the circular hub's periphery and secured with fastener. The blade rod with groove at its bottom end houses the arrestor levers and a cup for fastening the blade's central tubular sheath, so that the blades rotates around the blade rod freely. Two bearings, one at bottom end of the rod housed in the cup and the another one at the blade rod's farthest end is attached for friction free easy rotation of the blade around its rod.

The two blade arrester levers, mounted on a single plate is placed between the cup and the hub is secured by the rod's fastener firmly. The two arrestor levers which are six inches in length, one is positioned above the blade rod on its left side and the other lever is on its right side running parallel to it. The one that is located on the blade's upper left side prevents the blade from rolling over while in blade mode and the other one which is located on the blades right side parallel to the blade sheath prevents the blade's upper half tilting downward beyond the guide ring ramp, while in knife mode.

A round guide plate with wind vane is attached around the tubular structure with the aid of a bearing, for free rotation. Upon this round guide plate a circular ramp is provided on its outer rim, with props to make it run parallel to the guide plate, covering a 240 degree circular space on the guide plate, leaving 120 degrees of circular space for the blade movement in blade orientation. This 240 degree circular ramp enables the blade to travel against the wind in knife orientation preventing drag and enables smooth rotation of the mill.

Wind with its unidirectional flow pushes the blade in blade mode resulting in the vertical hub and the attached shaft to rotate in clockwise direction. This rotation results in generation of electrical energy by virtue of a generator attached at the earthward end of the vertical shaft.

The 240 degree circular guide ring ramp end is fixed on the guide plate's floor and then it starts to climb up gradually until it reaches parallel in height to the guide plate, supported by varying height props. This guide ring ramp after covering a distance of 240 degrees circular space on the guide plate ends abruptly. The blade in blade mode when pushed by the wind travels as blade mode for its 120 degree circular orbit, until its bottom edge meets the ramp's starting point on the guide plate floor.

Every blade has two edges known as first and second or forward and rear. The edge that travels upfront when the mill is in clockwise circular orbit is the front or first edge. Blade being broad long and flat its edge would be very thin so that drag on the mill while it is in knife mode is negligible. Likewise a blade has two ends, bottom end that is close to the central hub and to end which is far away from the hub.

A roller wheel is attached with the aid of an U clamp at the blade's bottom corner close to its rear edge, to enable the blade in knife mode to roll over the guide ring ramp with out friction or drag; at the same time preventing the blade from reverting to blade mode while it is traveling against the wind. Wind which flows on both sides of the mill would lift upwards the blade's front edge when it is traveling against the wind, exerting drag on the mill and the rear edge bottom wheel supported by the guide ring ramp would help in holding the blade in knife mode. Thus the blade is enabled to rotate constantly in one way clockwise circular orbit resulting in the mill's circular orbit resulting in continuous power generation as long as wind is flowing.

As stated above, blade while in blade mode being forced by the flowing wind would cover the 120 degree circular orbit with its front edge held higher than the guide ring, gets a gradual downward tilt when the rear edge roller wheel comes into contact with the ramps starting point and starts climbing upon the ramp due to wind force, resulting in change in orientation of the blade to knife mode.

Likewise when the blade's front edge after passing beyond the guide ring ramp's abrupt end continues to go until the rear edge falls down, due to ceasing of ramp support to the roller wheel. This sudden fall enables the blade to achieve its blade mode orientation. The guide ring's abrupt end is synchronized with the oncoming wind with the aid of wind vane.

Wind known for erratic and wavering results in wobbling, hence we have to provide preventive measures to eliminate any error in the mills working. For this the blade arrester is provided in this invention. Blade arrester which is placed firmly between the mill's hub and the blade rod cup, has two protruding levers measuring six inches in length. One lever is placed parallel on the left side of the blade's upper edge and the other one on the right side of the blade parallel to the blade's rod. The upper lever arrester prevents the blade from rolling over backwards due to the wind thrust while shifting its mode. Likewise the blade arrester right lever prevents the blade's front edge going below the level of the circular guide ring while in knife mode.

The wind vane is attached at the bottom of the guide plate, upon which the guide ring ramp is placed, holds the 120 degree circular orbit space of the guide plate always kept perpendicular to the on coming wind so that the flowing wind pushes the blade resulting in the mills circular orbiting.

Thus the vertical axis tilting blade windmill works without any tilting lever or gear mechanism. Aided by the flowing wind's thrust, blade roller wheel coupled with the guide ring ramp's abrupt end, wind vane and blade arrester levers, resulting in continuous clockwise circular orbiting of the mill helps in generation of electric energy.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1.-6. (canceled)

7. A vertically oriented variable tilting blade windmill device for capturing kinetic energy from a wind comprising
a vertical rotating drive shaft having a top end opposing a bottom end,
a central hub connectively attached to said top end having at least one wind capture arm comprising
a wind capture blade having a capture surface, a slicing edge, and a rubber lining proximal to said slicing edge comprising
an inner blade rod having a length and a first base end attached to said drive shaft through said central hub, and
an outer blade sleeve having a second base end with an upper blade guide post opposite a lower blade guide post to limit rotation of said wind capture blade wherein said outer blade sleeve is positioned to contain a majority of said inner blade rod and wherein said wind capture blade is attached lengthwise to said outer blade sleeve, and
a blade guide ring continuous for up to two hundred forty degrees arc surrounding said vertical rotating drive shaft positioned to rotate said wind capture blade ninety degrees arc around said inner blade rod as said wind pushes against said wind capture blade causing said central hub to rotate causing said wind capture blade to pass over said blade guide ring.

8. The device of claim 7 comprising a roller wheel operationally attached to said second base opposite said rubber lining, and said blade guide ring comprises a roller wheel on-ramp end opposite a roller wheel off-ramp end positioned to rotate said wind capture blade by causing said roller wheel to rotate said outer blade sleeve around said inner blade rod by up to ninety degrees as said wind pushes against said wind capture blade causing said central hub to rotate causing said wind capture blade to pass over said blade guide ring.

9. The device of claim 7 further comprising at least one rolling bearing operationally attached around said bottom end to enable rotation of said vertical rotating drive shaft about an attachment point which said rolling bearing is externally attached to.

10. The device of claim 7 further comprising an electrical generator connectively attached to said bottom end of said vertical rotating drive shaft enabling a generation of electricity.

11. The device of claim 9 further comprising an electrical generator connectively attached to said bottom end of said rotating drive shaft enabling a generation of electricity.

12. The device of claim 1 wherein when said wind capture blade is rotated into a knife mode when positioned over said blade guide ring presenting said slicing edge to said wind and wherein said wind capture blade is rotated into a knife mode when not positioned over said blade guide ring presenting said capture surface to said wind.

13. The device of claim 11 wherein when said wind capture blade is rotated into a knife mode when positioned over said blade guide ring presenting said slicing edge to said wind and wherein said wind capture blade is rotated into a knife mode when not positioned over said blade guide ring presenting said capture surface to said wind.

14. A vertically oriented variable tilting blade windmill device for capturing kinetic energy from a wind comprising
a vertical rotating drive shaft having a top end opposing a bottom end,
a central hub connectively attached to said top end having at least one wind capture arm comprising
a wind capture blade having a capture surface and a slicing edge comprising
an inner blade rod having a length and a first base end attached to said drive shaft through said central hub,
an outer blade sleeve having a second base end, and
a roller wheel operationally attached to said second base
wherein said wind capture blade is attached lengthwise to said outer blade sleeve, and
a blade guide ring having a roller wheel on-ramp end opposite a roller wheel off-ramp end continuous for up to two hundred forty degrees arc surrounding said vertical rotating drive shaft positioned to rotate said wind capture blade by causing said roller wheel to rotate said outer blade sleeve around said inner blade rod by up to ninety degrees as said wind pushes against said wind capture blade causing said central hub to rotate causing said wind capture blade to pass over said blade guide ring.

15. The device of claim 14 wherein said second base end further comprises connectively attached an upper blade guide post positioned ninety degrees arc away from a lower blade guide post to limit rotation of said wind capture blade.

16. The device of claim 14 wherein said wind capture blade further comprises a rubber lining opposite said roller wheel.

17. The device of claim 14 further comprising at least one rolling bearing operationally attached around said bottom end to enable rotation of said vertical rotating drive shaft about an attachment point which said rolling bearing is externally attached to.

18. The device of claim 14 further comprising an electrical generator connectively attached to said bottom end of said rotating drive shaft enabling a generation of electricity.

19. The device of claim 17 further comprising an electrical generator connectively attached to said bottom end of said rotating drive shaft enabling a generation of electricity.

20. The device of claim 14 wherein when said wind capture blade is rotated into a knife mode when positioned over said blade guide ring presenting said slicing edge to said wind and wherein said wind capture blade is rotated into a knife mode when not positioned over said blade guide ring presenting said capture surface to said wind.

21. The device of claim 19 wherein when said wind capture blade is rotated into a knife mode when positioned over said blade guide ring presenting said slicing edge to said wind and wherein said wind capture blade is rotated into a knife mode when not positioned over said blade guide ring presenting said capture surface to said wind.
